(19) United States
(12) Patent Application Publication
(10) Pub. No.: US 2013/0290014 A1
(43) Pub. Date: Oct. 31, 2013

(54) Method of Equipoise Enrollment of Subjects in Clinical Trials

(71) Applicant: William E. Butler, Boston, MA (US)

(72) Inventor: William E. Butler, Boston, MA (US)

(21) Appl. No.: 13/872,596

(22) Filed: Apr. 29, 2013

Related U.S. Application Data
(60) Provisional application No. 61/639,201, filed on Apr. 27, 2012.

(51) Int. Cl. G06Q 10/06; G06Q 50/22

(52) U.S. Cl. CPC G06Q 10/063112; G06Q 50/22
USPC 705/2

(57) ABSTRACT

In a method of enrollment selection of subjects for a clinical trial, a plurality of physician investigators is polled regarding each subject of a plurality of subjects. Responses of the plurality of physician investigators are aggregated for each subject. A subject of the plurality of subjects is enrolled in response to the subject having an aggregate of responses for the clinical trial that exceeds a predetermined minimum value of responses for the clinical trial.

### CROSS REFERENCE TO RELATED APPLICATIONS

This application claims priority to U.S. Provisional Application Ser. No. 61/639,201, filed on Apr. 27, 2012, titled “METHOD OF EQUIPOISE ENROLLMENT OF SUBJECTS IN CLINICAL TRIALS,” the disclosure of which is incorporated herein by reference in its entirety.

### FIELD OF THE DISCLOSURE

The invention is in the technical field of subject enrollment in human randomized clinical trials. More particularly, the invention is in the technical field of improving the scientific and ethical value of human randomized clinical trials by reducing human subject enrollment error.

### BACKGROUND

A randomized clinical trial is an experimental method of comparing the safety and efficacy of treatments for a disease condition. Potential subjects are selected for eligibility for enrollment based on the presence of the disease in question and their suitability for the alternate treatments being evaluated. An enrolled subject may be randomized to undergo one or another of the available treatments, and the outcome is measured with clinical, laboratory and imaging methods. If the subjects randomly assigned to a particular randomized arm show better outcome measures according to accepted statistical criteria at the end of the study than the subjects assigned to the other arms, then that arm is seen to be a better treatment for the disease condition.

In the planning phase of a randomized human clinical trial, a written description of the trial procedure including the eligibility and exclusion criteria for human subject enrollment is composed. This document is forwarded to human subject review committees of the proposed participating medical institutions. If an institutional human subjects committee approves the document, then the investigator at that institution may commence enrolling subjects for randomization. If a human subject meets the eligibility criteria and does not meet the exclusion criteria as specified in the document, then that subject may be enrolled and randomized.

The validity and the efficiency of conventional randomized clinical trials may be reduced by enrollment error. This may occur in a conventional randomized clinical trial because of a mismatch between the written eligibility and exclusion criteria of the study, and the state of the art understanding of the unresolved scientific questions as appreciated by expert peers. Moreover, it may be due to mismatch between the written eligibility and exclusion criteria and an individual subject, for example due to ambiguity in the document, such that a subject may be enrolled in a randomized trial who should not be enrolled.

Enrollment error thus may lessen the scientific value of a study. Moreover, it may undercut its ethical value if a subject is miss-enrolled in a study and then randomized between arms that carry risks of pain but are not consistent with optimal clinical outcome according to the state of the art.

However, there are greater levels of rigor possible for subject enrollment than conformance to sections of a written document. One such greater level of rigor consists of having each potential individual undergo peer review by a network of physician investigators who must concur in the aggregate that the enrollment of that human subject adds potential scientific value to the randomized clinical trial. The statistical analysis of the subjects seen by peer review as appropriate versus inappropriate for randomization represents a sharpening of the scientific and clinical questions of the trial.

Accordingly, there is a need for an invention for reducing enrollment error in randomized clinical trials. There is a need for a method that is based on the confidential screening of the enrollment of each potential human subject prior to randomization. There is a need for a method that is managed by means of a computer program that is part of this invention.

### SUMMARY OF THE INVENTION

The invention is directed to a method for reducing enrollment error in clinical trials. This method, managed by a computer program, is based on the confidential polling of the physician investigators who are experts in the scientific a clinical question that the clinical trial is intended to elucidate. The experts may be physician investigators who are based at the multiple institutions participating in the multicenter trial.

When an individual investigator identifies a subject as potentially appropriate for enrollment in a given clinical trial and the subject gives written consent for participation, the key characteristics (clinical, laboratory, or imaging) are conveyed by the computer program securely to the network of peer experts. Each peer expert, after reviewing the subject's information, votes by interacting with a graphical computer interface of the program whether randomization should be offered to the subject and which treatment arm that investigator judges is most apt to yield the best outcome. If a majority of the peer experts vote for randomization, this is taken to indicate that a peer review process sees that subject as being equipoise, and then randomization is offered to the subject by the computer program. If the subject wishes to continue participation in the trial, the computer program randomly assigns the subject a study arm, and the clinical trial may then proceed according to the standard art and science of clinical trials.

A system where the enrollment of each subject is subjected to expert peer review may lead to pools of subjects in each arm that are more finely balanced, i.e. at equipoise.

An aspect of the present invention pertains to a method of enrollment selection of subjects for a clinical trial. In this method, a plurality of physician investigators is polled regarding each subject of a plurality of subjects. Responses of the plurality of physician investigators are aggregated for each subject. A subject of the plurality of subjects is enrolled in response to the subject having an aggregate of responses for the clinical trial that exceeds a predetermined minimum value of responses for the clinical trial.

Another aspect of the present invention relates to a computer-readable storage medium having computer-readable instructions stored therein for enrollment selection of subjects for a clinical trial. When executed by one or more processors the instructions cause the one or more processors to perform method steps. In these method steps, a plurality of physician investigators is polled regarding each subject of a plurality of subjects. Responses of the plurality of physician investigators are aggregated for each subject. A subject of the plurality of subjects is enrolled in response to the subject having an aggregate of responses for the clinical trial that exceeds a predetermined minimum value of responses for the clinical trial.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is a flowchart of the algorithm for equipoise enrollment by the invention.

FIG. 2 is an example screen of the drag and drop system to manage the steps of the invention with the focus on the Enrollment Arm block.

FIG. 3 is an example screen of the drag and drop system to manage the steps of the invention with the focus on the Polling block.

FIG. 4 is an example screen capture of the clinical information to be entered into the investigational database in the invention.

FIG. 5 is an example screen capture of the computerized ballot presented to participating clinical investigators by the invention.

FIG. 6 is a block diagram of a computer network in which the computer program may be implemented.

### DETAILED DESCRIPTION OF THE INVENTION

The purpose of a randomized, multicenter clinical trial is to compare scientifically the net benefit of plural treatment arms for a given disease condition. In a conventional randomized clinical trial consenting human subjects are randomized to one of the treatment arms. The outcomes are measured and then compared statistically between the treatment arms. The decision for enrollment of a subject depends on the application to a potential subject of written inclusion and exclusion criteria. The risk of enrollment error, with its unwanted scientific and ethical ramifications, could be potentially reduced by the application of expert peer review of the enrollment of each subject. This invention is an equipoise enrollment method that employs physician investigator peer review applied to each potential subject. In the claimed method when an individual investigator identifies a subject as potentially appropriate for enrollment in a given clinical trial and the subject gives written consent for participation, the key characteristics (clinical, laboratory, or imaging) are conveyed securely to a network of peer experts on the topic of the trial. The peer experts may be physician investigators at other institutions who are participating in the clinical trial. The peer experts, after reviewing the subject's information, vote whether randomization should be offered to the subject and which treatment arm each expert judges is most apt to yield the best outcome. If a majority of the peer experts vote for randomization, this is taken to indicate that a peer review process sees that subject as being equipoise, and then randomization is offered to the subject. Thus, randomized clinical trials with this equipoise enrollment algorithm should reduce the risk of enrollment error and thus have both scientific and ethical advantages over conventional randomized clinical trials. This invention includes a computer program for managing the peer review and randomized arm assignment of this method of randomized clinical trials.

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects, as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

Assume there is a clinical trial dedicated to developing a scientific answer to a difficult clinical problem. As such, it seeks to enroll patients who suffer from that problem. There may be ambiguity as to whether a given patient has the precise clinical problem for which the clinical trials seeks to generate scientific information. Thus, the scientific validity of the clinical trial hinges in large part on whether it has enrolled patients with precisely the clinical problem of interest.

A plurality of medical centers may participate in the clinical trial. At each such center, a human subjects committee has approved participation by the center and by selected investigators (physicians, nurses, technical personnel, and support staff) in the clinical trial. A participating medical center as a matter of course will care for patients broadly in the field of the clinical trial, but many of the patients will not have the precise clinical problem that the clinical trial studies. The physician investigator and staff are alert for the presentation of patients with a clinical problem matching the subject of investigation of the clinical trial. In a standard randomized clinical trial, at enrollment the subject signs written consent to participate in the study, then is assigned to one of several randomized arms. An intervention is applied per the randomization result, and the subject's outcome is tracked. If a pool of subjects in one of the randomized arms has better outcomes than the other arms according to a statistical criterion of significance, then the study results that that arm is preferred.

However, in the equipoise clinical trial of this invention, between the decision to participate where the subject signs consent and the randomized arms there is an enrollment arm where the subject's suitability for enrollment is subjected to expert peer review by the physician investigators at the plural clinical centers participating in the trial. Subsequent to this enrollment arm, the clinical trial proceeds to the randomized arm as with a conventional randomized clinical trial.

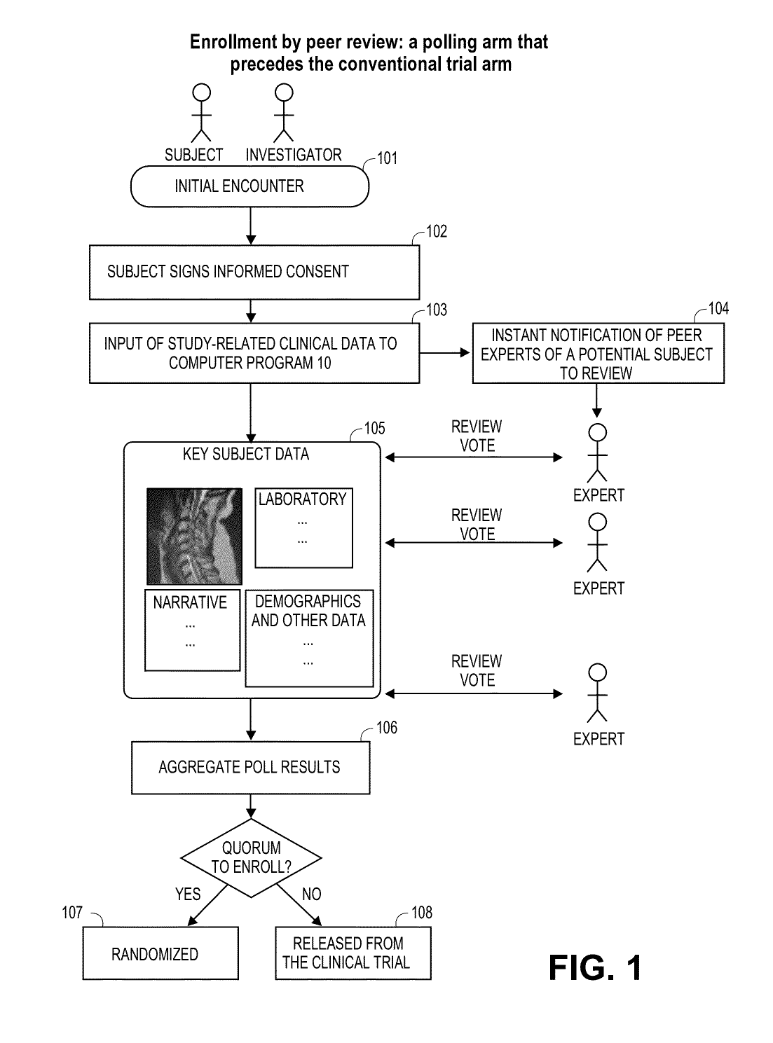

FIG. 1 is a flowchart of the enrollment arm in this invention. This invention includes a computer program 10 that manages in conjunction with a human operator certain steps depicted in the flowchart and executes others without human intervention. There is an initial encounter 101 between a patient and a physician investigator where the physician investigator studies the patient's clinical circumstance.

If the patient's clinical condition suitably matches topic of this clinical trial, the physician investigator may propose to the patient participation in the clinical trial. The structure of the study is reviewed by the physician investigator or designee with the patient. If the patient wishes to pursue participation, the patient signs written consent 102 to participate. Hereafter we refer to the patient as the subject.

The study personnel then input the key clinical data 103 as per the clinical trial protocol to a computer program 10 for storage in a database. The clinical trial supervisory staff reviews this data for accuracy, completeness, and compliance with regulatory and clinical trial protocol compliance. If the data satisfy study criteria they are released 104 by electronic mail, Twitter, or other rapid notification measures to the participating physician investigators for review. This notification is managed by the computer program 10 of this invention.

Each reviewing expert logs in by password to an encrypted computer link to this computer program 10, and reviews 105 the submitted clinical information for the subject in question. The computer program 10 prompts the reviewing expert as to whether it is appropriate to randomize the particular subject, and, if there were to be no randomization, which arm the reviewing expert recommends for that subject. The computer program 10 manages a timeline for this poll, tracks whether and if each reviewing expert has voted, and sends reminder notices as appropriate including to the principal investigator.

The computer program 10 aggregates and analyzes 106 the polling results of the many reviewing experts. This clinical trial may be intended as an exploratory study with the purpose of sharpening the clinical question. In which case the statistical characteristics of the subjects voted for randomization versus not voted for randomization are analyzed. The results of this analysis represent then an empirical assessment of peer expert judgment of which subjects are appropriate for randomization, meaning which subjects fall into the gap of missing medical knowledge.

If this clinical trial is not an exploratory study but formally includes randomization and if the majority of reviewing experts have voted to randomize 107, then the computer program 10 randomly assigns the subject the randomization arm of the clinical trial commences for that subject. The clinical trial then proceeds in the manner of a conventional randomized clinical trial. However, if the majority have voted not to randomize 108, then subject is released from the clinical trial.

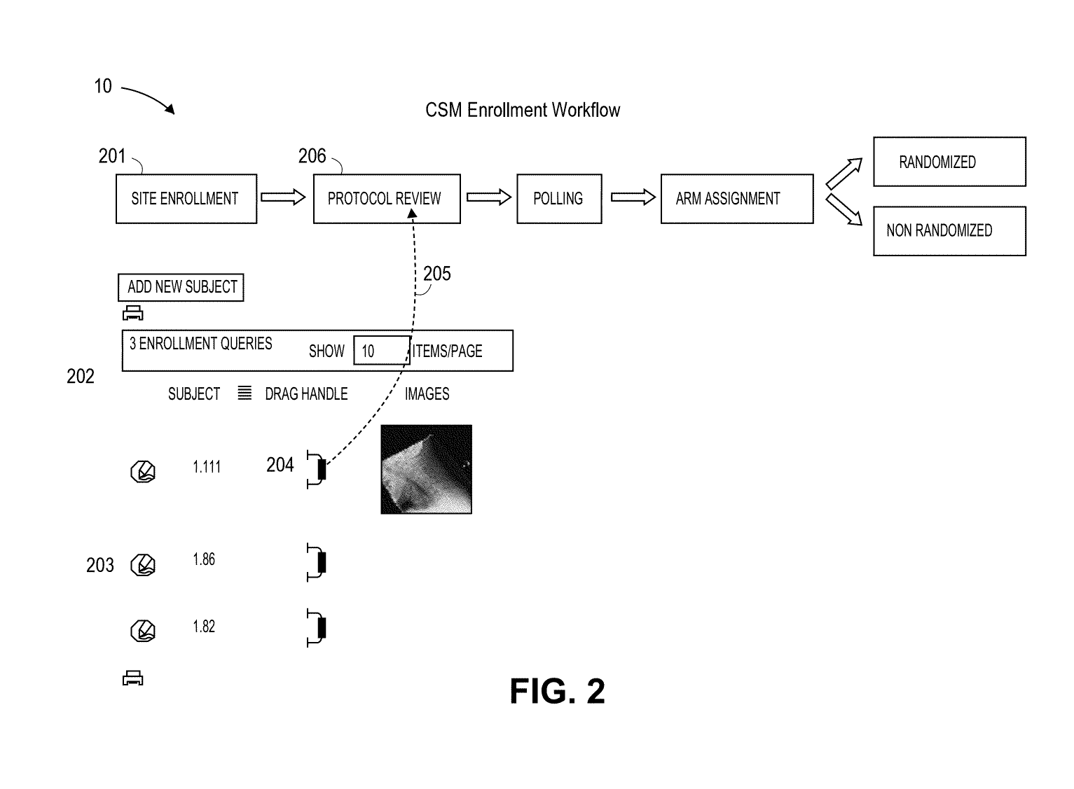

The computer program 10 that coordinates the step of the enrollment arm of this invention maintains a visual flowchart in a graphical user interface screen depicted in FIG. 2 that the investigational staff employs to manage and track said enrollment arm. The flowchart at the top 201 has several buttons, labeled Site Enrollment, Protocol Review, Polling, Arm Assignment, Randomized, Non Randomized. Each of these buttons represents a stage in the enrollment arm.

Site Enrollment signifies the steps at the physical site of the initial encounter between the patient and investigational personnel including the physician investigator who obtains written consent to participate in the study. In this block, the clinical information as appropriate for the clinical trial is first uploaded. Protocol Review signifies a supervisory step of the subject's clinical information for completeness, quality, and anonymization before it is released to the next block, Polling. Polling is where the multiple investigators are notified by the computer program 10 of a subject being ready for review, and where the investigators review the information and vote on randomization.

Arm Assignment is where the Polling results are analyzed and a decision executed as to randomization, and, if so, random assignment is made. The length of time a subject may remain in the Polling block, the quorum and the vote count to trigger Randomization may all be configured by principal investigators of the clinical trial in according with the clinical and scientific demands of the topic of study. Arm Assignment may be executed purely by the computer program 10, and accordingly a subject may be in this block momentarily. Randomization corresponds to the data arm of a conventional randomized clinical trial. Non-Randomization is listed to symbolize the option of a subject not being in the randomized arm but still participating in the study for non-randomized outcome data collection, if so specified by the clinical trial protocol.

Clicking with a computer mouse on any of these buttons causes a list of subjects 202 in that stage of the enrollment phase to be listed below the flow chart. The clicked button is highlighted with a double thickness bottom box border to specify which list of subjects 202 is displayed. Each listed subject has a pen icon on its row 203 which when clicked, displays a screen in the graphical user interface where uniquely that subject's information is displayed for editing by the user as appropriate. When a subject is ready for transition to the next block step a drag handle 204 for that subject is dragged (shown as mouse path 205) and dropped with the computer mouse onto the next block.

Dropping a subject's drag handle 204 onto the next block step (Protocol Review, in the example of FIG. 2) causes some automated actions by the computer program 10 managing the enrollment phase. For example, dragging the drag handle 204 on the example mouse path 205 to the Protocol Review block 206 cause an automatic electronic notification to be sent immediately to supervisory investigation personnel, including the principal investigators, that that subject is ready for the next stage of review before being released to all investigators for polling. If a principal investigator where to click on the Protocol Review box with a computer mouse, the list of subjects 202 would list all subjects in stage. The principal investigator could click on the edit icon 203 for each, make changes as appropriate, drag with the handle back to the Site Enrollment block step, which would cause the computer program 10 to send a notification to the investigators handling the initial enrollment for the subject that further tasks need to be complete for the subject to be ready for the Protocol Review

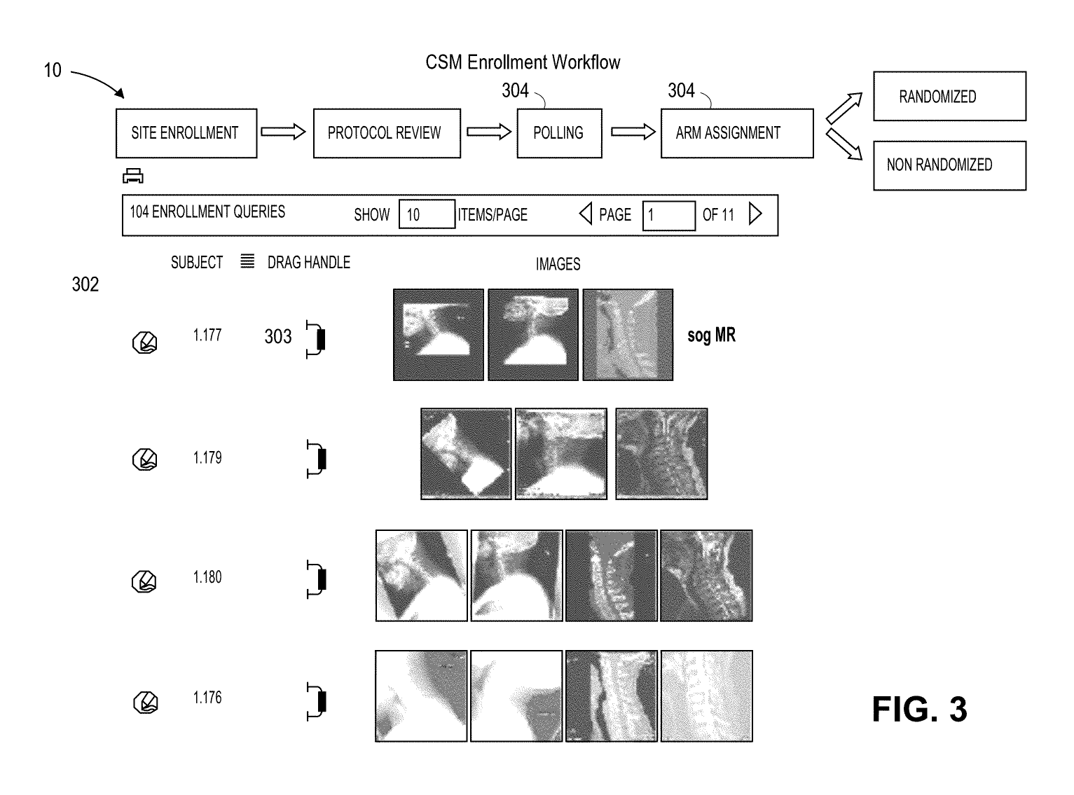

FIG. 3 shows by way of example that if another block is clicked, in this case Polling 301, the subjects in that block of the enrollment phase are listed 302. The subjects may transition to the next block Arm Assignment automatically by the computer program 10 based on the prespecified quorum and vote counting rules, or a human manager may override by clicking on the drag handle 303 and dropping on the next block 304.

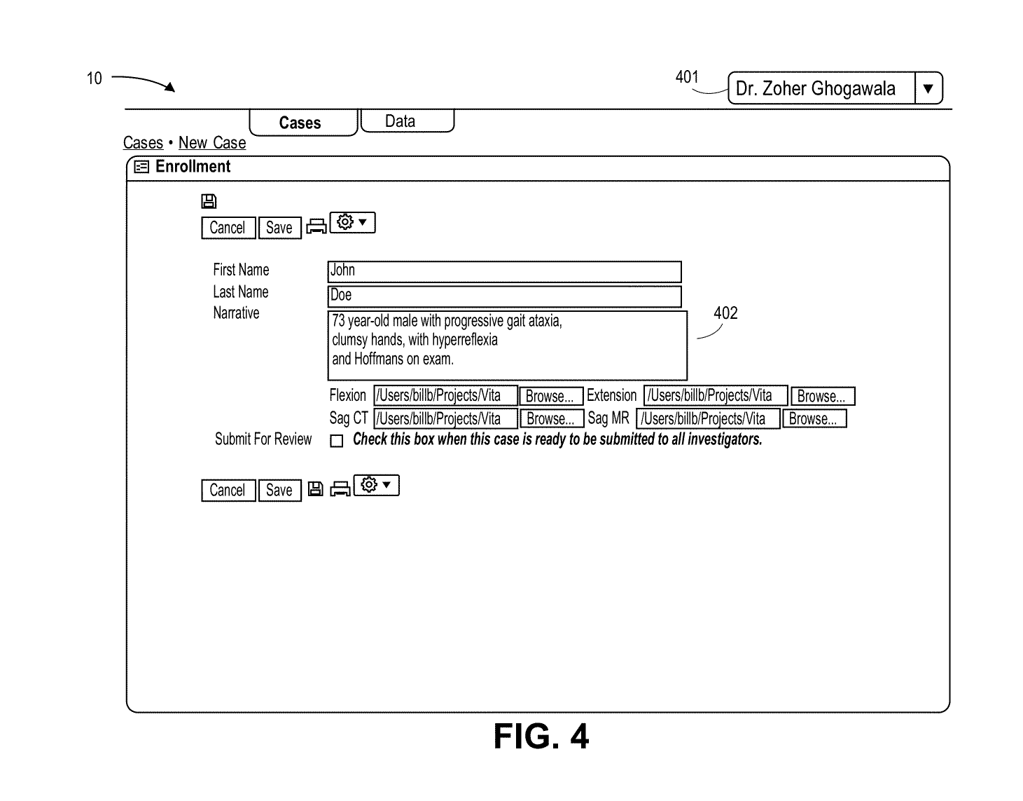

FIG. 4 is an example screen of the computer program 10 for upload of clinical information per the Site Enrollment block of FIG. 3. In FIG. 4, as in all aspects of this computer program 10, a member of the study personnel logs in using a password and all data transmission and storage are encrypted. The name of the authenticated user 401 is displayed. The subject's clinical information as called for by the Polling block are entered in the computer form 402.

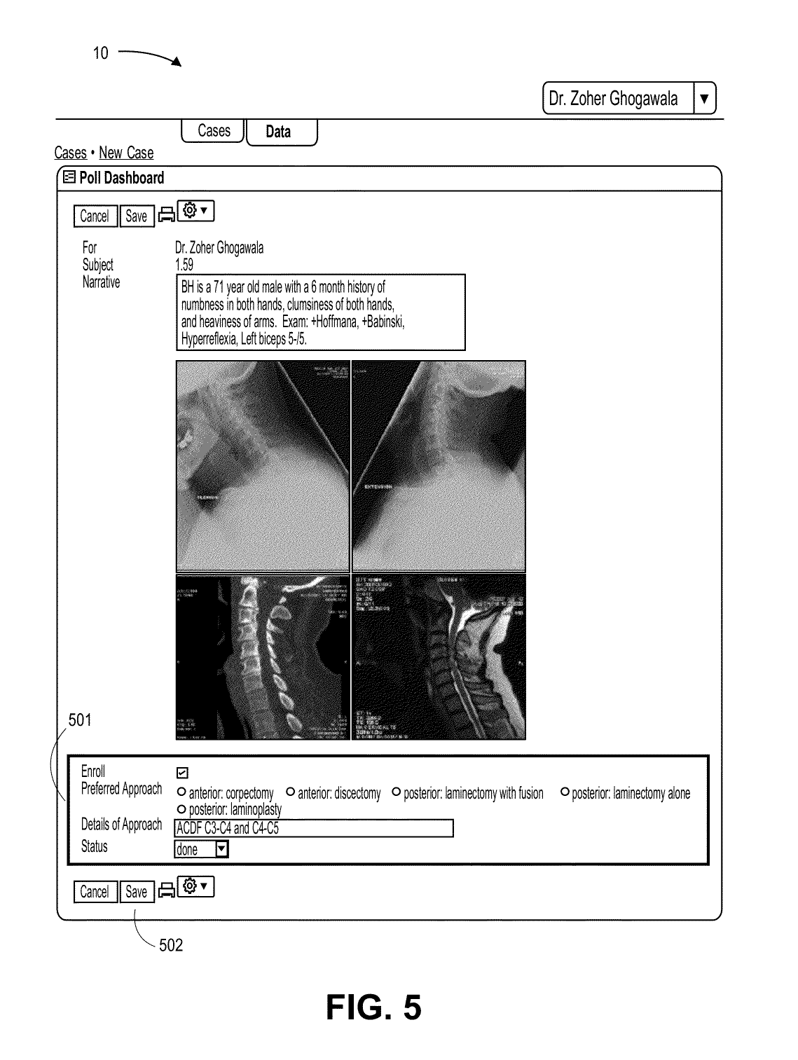

FIG. 5 is an example computer form 501 that is sent to each peer expert as part of the Polling block. The expert reviews the information, votes whether it is appropriate to enroll for Randomization, and specifies preferences for other aspects including randomization. When satisfied, the voting expert clicks the Save button 502, causing these votes to be stored for analysis when a vote quorum is achieved. The peer experts need not necessarily be the clinical investigators of the study. The computer program 10 of this invention does not contain this as a restriction.

The computer program 10 employs a three-tier architecture commonly as employed in electronic commerce. There may be a database tier case implemented with the Structured Query Language (SQL) database Postgresql. There may be a server application later implemented in the Java programming language. The client side graphical user interface may be implemented in a mixture of Hyper Text Markup Language (HTML) and JavaScript. The server computers are protected by hardware and software firewalls. User name and password authentication is required for interaction between the client side and the server side. All communication between the client and server sides is encrypted with Secure Sockets Layer (SSL). While this is a commonly employed computer architecture for secure client-server applications, those skilled in the art of client server computer programming and administration will recognize that a similar purpose could be achieved with other languages and systems designs.

The advantages of the invention include, without limitation, improvement in the scientific and ethical value of randomized clinical trials with human subjects. The scientific and ethical improvement both derive from the peer review by multiple physician investigators of each subject prior to randomization. In the example clinical trial used in these Figures, the Cervical Spine Myelopathy (CSM) trial, the question is anterior versus posterior surgical approach to decompress the spinal cord when it is compressed by cervical spine stenosis (degenerative enlargements in the bones and soft tissues of the cervical spine). There is considerable risk and discomfort associated with each incision and approach. However, it is unknown which is more effective and more safe, or whether the safety and efficacy of the two approaches varies according to details of the subjects condition.

In a conventional randomized clinical trial, a subject who meets the criteria in the text of the protocol and signs consent may be randomized. In this invention, each subject requires peer review prior to randomization. This ensures a high standard of evidence and a reflection of the consensus of the state of the art that each subject falls into the unknown category. Accordingly, the outcome results must be more likely to provide a meaningful answer to the question at hand. Moreover, the high standard of evidence prior to randomization is likely to exclude from randomization some subjects for whom the expert consensus is that one randomized arm is preferred to the others and that the subject ethically ought not be randomized.

This invention has the further scientific advantage of offering for publication a snapshot empiric characterization of the state of the art estimate of equipoise, where equipoise is taken to mean the condition where the arms of randomization are estimated as equal.

This invention has the potential further advantage of, by elevating the scientific and ethical value of a randomized clinical trial, increasing the ease of new subject recruitment. In a broad aspect, the invention is a superset of the conventional randomized clinical trial. In this invention, each subject there is an enrollment phase prior to the randomization. In the enrollment phase, physician investigators at multiple centers are polled as the appropriateness of randomization of each potential subject. The enrollment phase is managed by a computer program 10, using blocks on a workflow chart with drag and drop heuristics. If for a subject there is a quorum of physician investigators who review the subjects data and a majority vote in favor of randomization, then the subject enters the randomized arm of the clinical trial that is akin to a conventional randomized clinical trial.

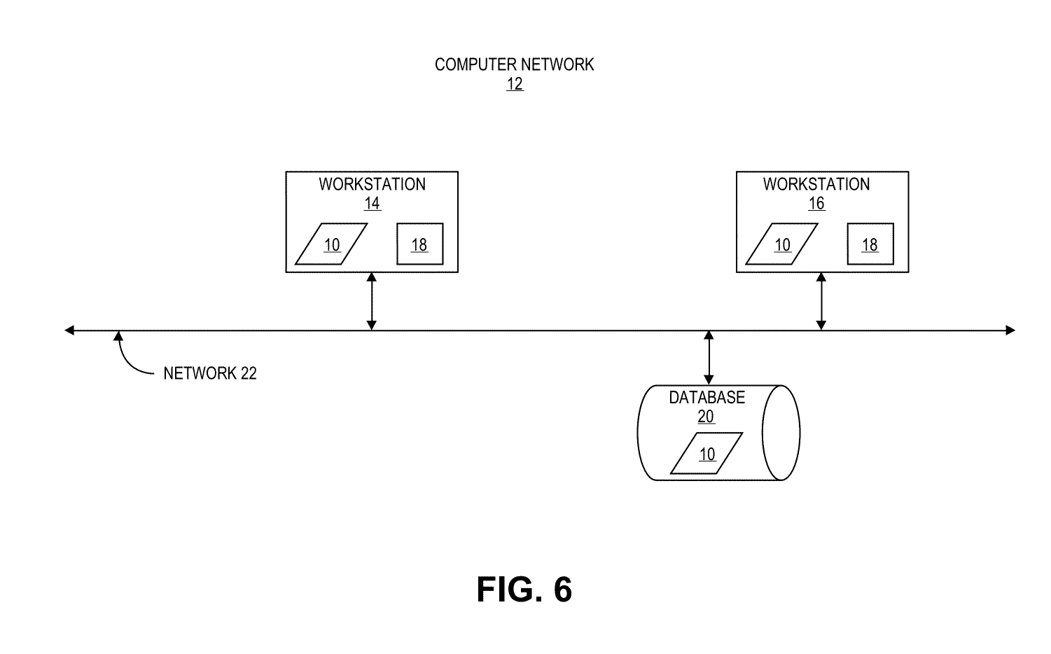

FIG. 6 is a block diagram of a computer network 12 in which the computer program 10 may be implemented. As shown in FIG. 6, the computer network 12 includes, for example, a workstation 14, and 16 that each include a processor 18, a database 20, and a network 22. The network 22 is configured to provide a communication path for each device of the network 22 to communicate with the other devices. Additionally, the computer network 22 may be the Internet, a public switched telephone network, a local area network, private wide area network, wireless network, and the like communication channels.

In various aspects, methods described herein may be executed on either or both of the workstations 14 and 16. For example, in an aspect of the invention, the workstation 14 is configured to execute the method of enrolling subjects for a clinical trial and/or managing the enrollment process, provide output for display and receive input from the database 20. In various other aspects, one or both of the workstations 14 and 16 may be configured to execute the method of enrolling subjects for a clinical trial and/or managing the enrollment process individually or co-operatively.

Additionally, data associated with enrolling subjects for a clinical trial and/or managing the enrollment process, and the like, may be stored on the database 20. The database 20 may additionally be configured to receive and/or forward some or all of the stored data. Moreover, in yet another aspect, some or all of the computer network 12 may be subsumed within a single device.

Although FIG. 6 depicts a computer network, it is to be understood that the various aspects are not limited to operation within a computer network, but rather, the some or all of the aspects may be practiced in any suitable electronic device. Accordingly, the computer network depicted in FIG. 6 is for illustrative purposes only and thus is not meant to limit the various aspects in any respect.

The invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

The invention may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels. In an aspect, the invention may be web-based. For example, a server may operate a web application to allow the invention to operate in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

In an aspect, the invention may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various aspects of the invention, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the invention as described herein are optionally stored on a tangible non-transitory storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

While the foregoing written description of the invention enables one of ordinary skill to make and use what is considered presently to be the best mode thereof, those of ordinary skill will understand and appreciate the existence of variations, combinations, and equivalents of the specific aspect, method, and examples herein. The invention should therefore not be limited by the above described aspect, method, and examples, but by all aspects and methods within the scope and spirit of the invention.

1. A method of enrollment selection of subjects for a clinical trial utilizing at least one computer, the method comprising the method steps of:
polling a plurality of physician investigators regarding each subject of a plurality of subjects;
aggregating responses of the plurality of physician investigators for each subject; and
enrolling a subject of the plurality of subjects in response to the subject having an aggregate of responses for the clinical trial that exceeds a predetermined minimum value of responses for the clinical trial.

2. The method according to claim 1, further comprising the step of:
evaluating each subject based on the suitability of the subject for an alternative treatment.

3. The method according to claim 2, further comprising the step of:
enrolling the subject in an arm of the clinical trial for the alternative treatment in response to the subject having an aggregate of responses for the arm of the clinical trial that exceeds a predetermined minimum value of responses for the arm of the clinical trial.

4. The method according to claim 1, further comprising the step of:
evaluating each subject based on the presence of a disease studied in the clinical trial.

5. The method according to claim 1, further comprising the step of:
evaluating each subject based on the exclusion criteria of the clinical trial.

6. The method according to claim 1, further comprising the step of:
randomizing each enrolled subject in response to the subject being enrolled in the clinical trial.

7. The method according to claim 1, further comprising the step of:
tracking an outcome for each enrolled subject in response to the subject being enrolled in the clinical trial.

8. The method according to claim 1, further comprising the step of:
displaying medical data for each subject to the plurality of physician investigators.

9. The method according to claim 1, further comprising the step of:
accepting a response vote for each subject from each of the plurality of physician investigators.

10. The method according to claim 1, further comprising the step of:
receiving written consent from each subject.

11. A computer-readable storage medium having computer-readable instructions stored therein for enrollment selection of subjects for a clinical trial, which when executed by one or more processors cause the one or more processors to perform the method steps of:
polling a plurality of physician investigators regarding each subject of a plurality of subjects;
aggregating responses of the plurality of physician investigators for each subject; and
enrolling a subject of the plurality of subjects in response to the subject having an aggregate of responses for the clinical trial that exceeds a predetermined minimum value of responses for the clinical trial.

12. The computer-readable storage medium according to claim 11, further comprising the step of:
evaluating each subject based on the suitability of the subject for an alternative treatment.

13. The computer-readable storage medium according to claim 12, further comprising the step of:
enrolling the subject in an arm of the clinical trial for the alternative treatment in response to the subject having an aggregate of responses for the arm of the clinical trial that exceeds a predetermined minimum value of responses for the arm of the clinical trial.

14. The computer-readable storage medium according to claim 11, further comprising the step of:
evaluating each subject based on the presence of a disease studied in the clinical trial.

15. The computer-readable storage medium according to claim 11, further comprising the step of:
evaluating each subject based on the exclusion criteria of the clinical trial.

16. The computer-readable storage medium according to claim 11, further comprising the step of:
randomizing each enrolled subject in response to the subject being enrolled in the clinical trial.

17. The computer-readable storage medium according to claim 11, further comprising the step of:
tracking an outcome for each enrolled subject in response to the subject being enrolled in the clinical trial.

18. The computer-readable storage medium according to claim 11, further comprising the step of:
displaying medical data for each subject to the plurality of physician investigators.

19. The computer-readable storage medium according to claim 11, further comprising the step of:
accepting a response vote for each subject from each of the plurality of physician investigators.

20. The computer-readable storage medium according to claim 11, further comprising the step of:
receiving written consent from each subject.
